(19) United States
(12) Patent Application Publication
(10) Pub. No.: US 2006/0120837 A1
(43) Pub. Date: Jun. 8, 2006

(54) Wheelchair elevator

(76) Inventors: Hsuen-Haw Hung, Kaohsiung City (TW); Chuan-I Hung, Kaohsiung City (TW); Chiu-Ju Hung, Kaohsiung City (TW); I-Tien Hung, Kaohsiung City (TW)

Correspondence Address: Hsuen-Haw Hung, P.O. BOX 90, Tainan City, 70499, TW

(21) Appl. No.: 11/002,252

(22) Filed: Dec. 3, 2004

(51) Int. Cl. B65F 9/00

(52) U.S. Cl. 414/347

(57) ABSTRACT

A wheelchair elevator includes a base, a support frame, and a movable flat. The support frame is positioned on the base, consisting of two X-shaped frames, and the movable flat is fixed on the support frame, having a receptive base respectively at two lengthwise sides a little lower than the flat. The receptive base has a lengthwise wheel passageway and a stopper behind the passageway. The flat with the support frame is raised up or lowered down by a shrinkable air tube pumped by a swing rod. Then wheelchair can be pushed on the two wheel passageways of the receptive base and stopped by the stoppers, and then the flat with the support frame is raised by pumping air into the shrinkable air tube to a needed height for boarding in a vehicle or lowered down from the vehicle.

### BACKGROUND OF THE INVENTION

1. Field of the Invention

This invention relates to a wheelchair elevator, particularly to one composed of a base, a support frame and a movable flat. The support frame is fixed on the base, consisting of two X-shaped frames, and the movable flat fixed on the support frame, which is possible to be raised up and lower down. The flat has a receptive base with two passageways at two sides for the wheels of a wheelchair to move thereon. Then the support frame can be raised up and down by a shrinkable air tube pumped by a swing rod, then the wheelchair is also raised up or lowered down together with the flat for boarding on or getting down a vehicle.

2. Description of the Prior Art

No-obstacle environment and accommodations for the handicapped and disabled are not enough nowadays, and social welfare organizations has appealed for taking care of basic rights for the disabled and weak-minded, and those using wheelchairs need a sloped passageways for boarding on or getting down a vehicle, but most vehicles are not provided with means for elevating wheelchairs. When disabled or crippled persons are to board on or get down a vehicle, two other persons are needed to help them to board on or get off, and the wheelchair is to be folded and placed on a vehicle, taking time and manual work. Should there happen any accident, the user might be hurt or face some risk.

### SUMMARY OF THE INVENTION

The purpose of the invention is to offer a wheelchair elevator for raising up or lowering down and transporting a wheelchair conveniently.

The feature of the invention is a movable flat provided with a little lower receptive base at two sides, and a passageway formed in the receptive base and a stopper fixed at the end of the passageway.

### BRIEF DESCRIPTION OF DRAWINGS

This invention will be better understood by referring to the accompanying drawings, wherein:

FIG. 1 is a perspective view of a wheelchair elevator in the present invention;

FIG. 2 is a side view of the wheelchair elevator in the present invention;

FIG. 3 is a side view of the wheelchair elevator in the lowered condition in the present invention;

FIG. 4 is a side view of a wheelchair pushed on the wheelchair elevator in the present invention; and,

FIG. 5 is a side view of a wheelchair moved on and raised up by the wheelchair elevator in the present invention.

### DETAILED DESCRIPTION OF THE PREFERRED EMBODIMENT

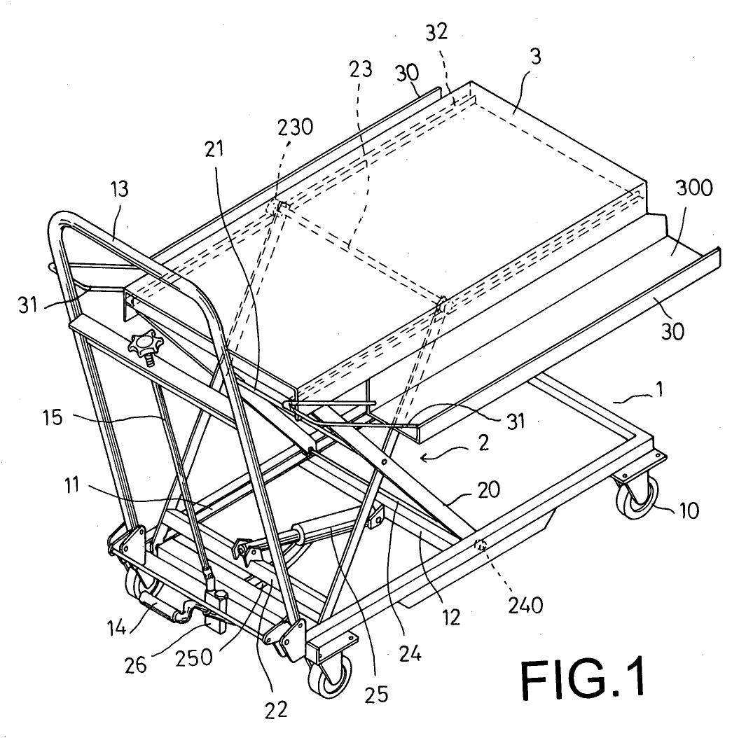

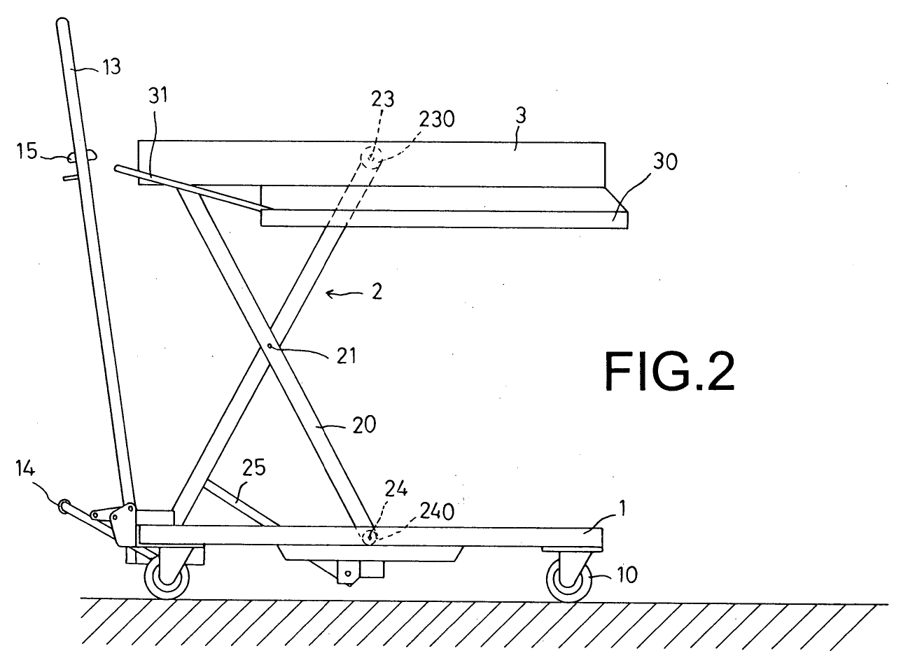

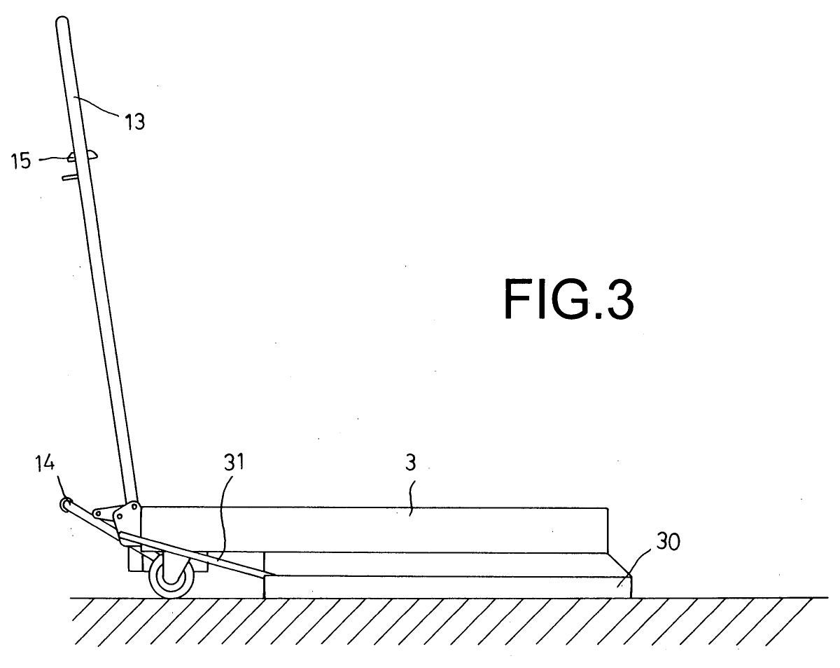

A preferred embodiment of a wheelchair elevator in the present invention, as shown in FIGS. 1, 2 and 3, includes a base 1, a support frame 2 and a movable flat 2 as main components combined together.

The base 1 is provided with plural castors 10 for standing on the ground, a slide rail 11 fixed at the inner wall of the two lengthwise sides, a fix rod 12 positioned transversely in an intermediate portion, an inverted U-shaped push rod 13 vertically positioned at a rear side, a swing rod 14 provided below the push rod 13 and a pull lever 15 positioned vertically between the two sides of the push rod 13.

The support frame 2 is combined on the base 1, having two X-shaped frames 20—a first and a second one, and a pivot 21 pivotally connected between the two X-shaped frames 20. Then the first X-shaped frame 20 has its lower end fixed with the base 1, and its upper two ends firmly combined with the movable flat 3. The support frame 2 further has a fix rod 22 secured between the two lower portions of the first X-shaped frame 20, a connective rod 23 is connected between the two upper ends of the first X-shaped frame 20, arid a connective rod 24 is connected between the two lower ends of the second X-shaped frame 20, and the two ends of the connective rod 23 are further fixed respectively with a roller 230, and so are the two ends of the connective rod 24 with a roller 240. The two rollers 230 are located on the slide rail 32 of the movable flat 3, and the two rollers 240 are located on the slide rail 11 of the base 1. Further, a shrinkable air tube 25 is provided in a lower portion of the support frame 2, having one end connected to the fix rod 12 of the base 1 and an air tube 250 connected with a control valve 26 fixed with the base 1 for raising and lowering the support frame 2.

The movable flat 3 is fixed on the support frame 2, having a receptive base 30 located at two sides of the flat 3 and a little lower than the flat 3. The receptive base 30 is provided with a lengthwise passageway 300 and a U-shaped stopper 31 behind the passageway 300, and a slide rail 32 fixed respectively at the two sides of the inner bottom for rollers 230 of the connective rod 23 to slide thereon.

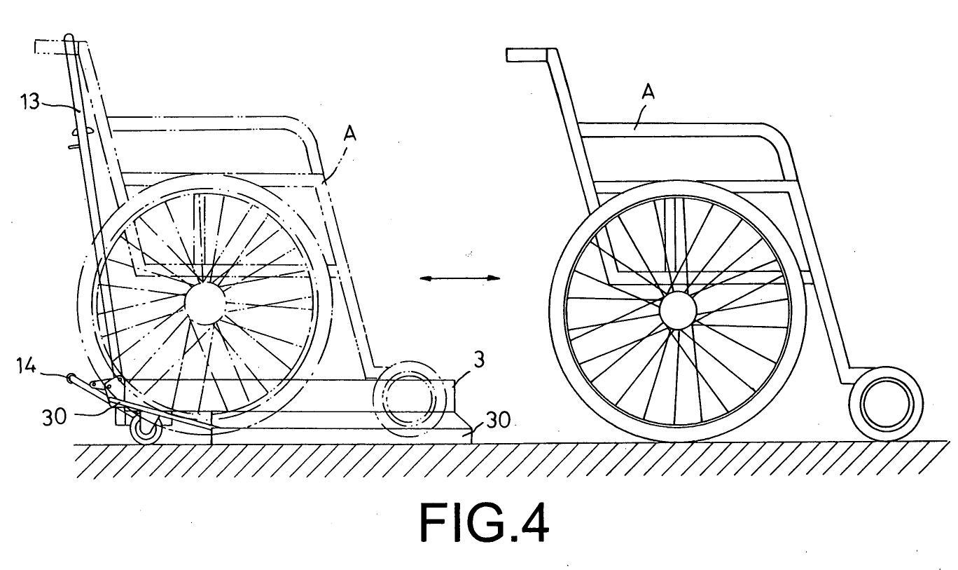

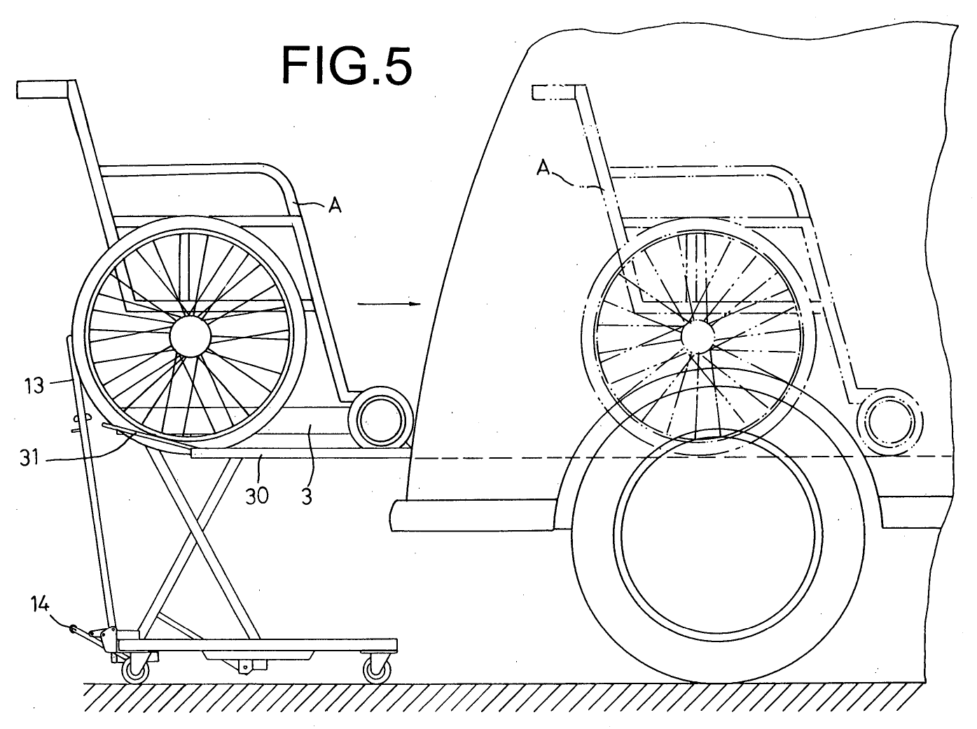

In using, refereeing to FIGS. 4 and 5, firstly, in order to lower the wheelchair elevator, pull up the pull lever 15 of the base 1, forcing the shrinkable air tube 25 exhausts out the air inside, than the shrinkable air tube 25 may shrink to let the support frame 2 gradually move down together with the movable flat 3 until the flat 3 reaches the ground. The a wheelchair (A) is pushed backward from the front side, with the wheels moving on the two receptive bases 30 and stopped by the stoppers 31, and then the wheels are put on brake. Then the swing rod 14 is stepped to swing for air pumped into the shrinkable air tube 25 so the shrinkable air tube 25 may lengthen to rise up the support frame 2 gradually together with the flat 3 until the flat 3 reaches the same height as the floor of a vehicle. Then pedaling the swing rod is stopped to let the flat 3 positioned at the height as the same as the floor of a vehicle for the wheelchair (A) possible to be pushed in the vehicle.

On the contrary, if a wheelchair is to be lowered from a vehicle to the ground, the operational processes just described can be reversely repeated to attain the purpose.

While the preferred embodiment of the invention has been described above, it will be recognized and understood that various modifications may be made therein and the appended claims are intended to cover all such modifications that may fall within the spirit and scope of the invention.

What is claimed is:

1. A wheelchair elevator comprising:
a base provided with a slide rail respectively at two sides, a push lever, a swing rod and a pull rod at one side;
a support frame fixed on said base, consisting of two X-shaped frames pivotally connected with each other with a pivot, a first X-shaped frame having its lower two ends fixed with said base and its upper two ends fixed with a movable flat, the first X-shaped frame having its upper two ends connected with a connective rod, a second X-shaped frame having its lower two ends connected with a connective rod, said connective rods respectively having two ends respectively fixed with a roller, said rollers of the lower ends of said second X-shape frame resting on a slide rail of said base, a shrinkable air tube provided in a lower portion of said support frame, one end of said shrinkable air tube connected with said base; and,
said movable flat fixed on said support frame and having a receptive base respectively at two lengthwise sides, each said receptive base positioned a little lower than; said flat and provided with a wheel passageway for the wheels of a wheelchair to move thereon, and a U-shaped stopper fixed behind said passageway for stopping securely the wheels, and a slide rail at two lengthwise sides under the bottom of said flat for said rollers of said support frame to rest and slide thereon when said support frame is raised or lowered.
